(19) United States
(12) Patent Application Publication
(10) Pub. No.: US 2026/0278769 A1
(43) Pub. Date: Sep. 17, 2026

(54) METHOD FOR DEFECT DETECTION ON MACHINED SURFACE 3D POINT CLOUD BASED ON DIFFUSION MODEL

(71) Applicant: ZHEJIANG UNIVERSITY, Zhejiang (CN)

(72) Inventors: Lemiao QIU, Zhejiang (CN); Zheyuan ZHOU, Zhejiang (CN); Le Wang, Zhejiang (CN); Naiyu Fang, Zhejiang (CN); Zili Wang, Zhejiang (CN); Shuyou ZHANG, Zhejiang (CN)

(73) Assignee: ZHEJIANG UNIVERSITY, Zhejiang (CN)

(21) Appl. No.: 19/683,735

(22) Filed: May 21, 2026

Related U.S. Application Data
(63) Continuation of application No. PCT/CN2025/108609, filed on Jul. 15, 2025.

(30) Foreign Application Priority Data
Mar. 17, 2025 (CN) 202510309898.9

(51) Int. Cl. G06T 7/00; G06T 3/40; G06T 7/10; G06V 10/26; G06V 10/762; G06V 10/82

(52) U.S. Cl. CPC G06T 7/0004; G06T 3/40; G06T 7/10; G06V 10/26; G06V 10/762; G06V 10/82; G06T 2207/10028; G06T 2207/20081; G06T 2207/20084; G06T 2207/30164

(57) ABSTRACT

Method for detecting defects on machined surface 3D point cloud based on diffusion model, comprising: obtaining 3D point clouds of machined surfaces of defect-free industrial products and obtain defect 3D point clouds, thereby constructing a training set; establishing improved diffusion model based on displacement iterative reconstruction and training the model using training set until loss function converges; obtaining 3D point cloud of machined surface of industrial product to be detected, performing point cloud preprocessing, reconstructing it via reconstruction model; detecting and segmenting 3D point cloud to be detected and its reconstructed point cloud via detection function to obtain defect detection classification and localization results. Present invention is applicable to defect detection based on 3D representations, solve slow inference speed and high video memory consumption in existing 3D defect detection methods, contributes to realization of efficient, rapid, and accurate 3D defect detection and quality inspection of industrial assembly line products.

### CROSS-REFERENCE TO RELATED APPLICATION

This application is a continuation of international application of PCT application serial no. PCT/CN2025/108609, filed on Jul. 15, 2025, which claims the priority benefit of China Application No. 202510309898.9, filed on Mar. 17, 2025. The entirety of each of the above-mentioned patent applications is hereby incorporated by reference herein and made a part of this specification.

### TECHNICAL FIELD

The present invention relates to a method for detecting defects on a machined surface, pertains to the field of defect detection, and specifically relates to a method for defect detection on a machined surface 3D point cloud based on a diffusion model.

### BACKGROUND OF THE INVENTION

The goal of defect detection is to identify data instances containing defects and to precisely locate the specific positions of these defects. This task is widely applied in multiple fields and plays a crucial role in quality control within industrial production. Three-dimensional (3D) point clouds possess inherent modal advantages, capable of avoiding blind spots that occur in 2D image-based defect detection, which can lead to false detections or missed detections. Consequently, 3D point cloud defect detection technology has developed and is playing an increasingly important role in advanced manufacturing and precision machining.

However, the discrete and disordered nature of 3D point cloud data makes extracting features from it more difficult than from 2D images. Concurrently, because defect instances are relatively rare, using only normal instances as a sole training source can cause the trained defect detector to encounter domain shift problems, rendering it unable to correctly handle abnormal instances. These issues highlight the necessity and urgency of developing efficient 3D point cloud defect detection frameworks. Similar to traditional 2D image defect detection, current 3D point cloud defect detection methods can be primarily categorized into embedding-based methods and reconstruction-based methods. Embedding-based methods involve using a pre-trained encoder to extract features and mapping them onto a normal distribution for learning. If a distribution falls outside a predetermined interval, it is regarded as a defect. Most existing 3D defect detection methods are based on a memory bank mechanism, storing some representative features during the training stage to implicitly construct a feature distribution. In the testing stage, the existence of a defect is judged by calculating the Euclidean distance between the input test object and all template point clouds stored in the memory bank. Reconstruction-based methods train a network to accurately reconstruct normal point clouds. Since defect point cloud instances are not included in the training process, a model trained only using normal point cloud instances cannot correctly reconstruct defect point cloud instances encountered during the testing stage.

Existing methods face two key problems: high resource costs and irreparable reconstruction. First, memory bank-based methods store all features from the training stage, meaning each test point cloud must be compared with all samples in the memory bank. This drastically increases the burden on memory and the cost of inference time. Such inefficiency makes these types of methods difficult to apply in actual industrial production lines. Second, the masked autoencoder mechanism only reconstructs the masked portions of the input, meaning defects potentially existing in the unmasked portions are retained. This contradicts the basic assumption of comparing the original defective point cloud with a reconstructed anomaly-free version. These methods inevitably lead to erroneous reconstructions, thereby weakening their effectiveness in accurately locating defects. In summary, existing technologies struggle to achieve rapid and accurate 3D point cloud defect detection tasks.

### SUMMARY

To solve the problems existing in the background art, the present invention provides a method for defect detection on a machined surface 3D (three-dimensional) point cloud based on a diffusion model.

The technical solution adopted by the present invention is:

A method for defect detection on a machined surface 3D point cloud based on a diffusion model, comprising:
1) Obtaining a plurality of 3D point clouds of machined surfaces of defect-free industrial products and sequentially performing data augmentation and point cloud preprocessing, thereby obtaining defect 3D point clouds and constructing a training set.
2) Establishing an improved diffusion model based on displacement iterative reconstruction, and inputting the training set into the improved diffusion model for training until a loss function of the improved diffusion model converges, thereby obtaining a trained reconstruction model.
3) Obtaining a 3D point cloud of a machined surface of an industrial product to be detected, performing the same point cloud preprocessing as in step 1), and then inputting the preprocessed point cloud into the reconstruction model for processing to obtain a reconstructed point cloud upon completion of processing.
4) Detecting and segmenting the 3D point cloud to be detected and the reconstructed point cloud thereof via a detection function to obtain defect detection classification and localization results, thereby completing the defect detection of the machined surface of the industrial product.

The present invention is oriented toward 3D form expression, reconstructing defect-free features corresponding to input samples based on a diffusion model, detecting and segmenting by comparing original features and reconstruction via a clustering algorithm and distance function, and performing data augmentation via a novel 3D point cloud defect simulation strategy.

In step 1), for each 3D point cloud of the machined surface of a defect-free industrial product, data augmentation comprising global random rotation and local random deformation is sequentially performed on the 3D point cloud. When performing global random rotation, a randomly generated 3×3 rotation matrix is dot-multiplied with the point cloud matrix of the 3D point cloud to obtain a rotated 3D point cloud. This random rotation simulates partial point clouds obtained from scanning at different angles to enhance the model's robustness to input point clouds at arbitrary angles. Then, local random deformation is performed, wherein partial points in the rotated 3D point cloud are randomly selected for displacement to simulate defect styles including protrusions, indentations, and damage, thereby enhancing the model's ability to reconstruct corresponding defect-free samples when dealing with real 3D defects. Finally, a data-augmented 3D point cloud is obtained.

In step 1), the data-augmented 3D point cloud undergoes point cloud preprocessing. First, normalization processing is performed, followed by translation and scaling of the data-augmented 3D point cloud. Then, it undergoes random down-sampling to a preset number of point clouds, finally obtaining a processed defect 3D point cloud and constructing the training set.

In step 2), the improved diffusion model based on displacement iterative reconstruction comprises a PointNet point cloud network encoder and an improved diffusion decoder. During the training process, the improved diffusion model further comprises a noise addition function. The defect 3D point clouds are passed through the PointNet point cloud network encoder for feature extraction to obtain shape encoding features of the defect 3D point clouds as a latent shape embedding code c. Simultaneously, the defect 3D point clouds are passed through the noise addition function to generate a set of masked point clouds

$${𝒫}_{a}^{( T )}$$

at time T having Markov chain properties. The shape encoding features of the defect 3D point clouds are input into the improved diffusion decoder for processing to output a displacement vector Δ^{(T-1)} at time T−1. The masked point cloud

$${𝒫}_{a}^{( T )}$$

at time T and the displacement vector Δ^{(T-1)} at time T−1 are added to obtain a reconstructed point cloud

$${𝒫}_{r}^{( T - 1 )}$$

at time T−1. The displacement vector Δ^{(T-1)} at time T−1 and the latent shape embedding code c are input into the improved diffusion decoder for processing to output a displacement vector Δ^{(T-2)} at time T−2. The iterative process is repeated; at each iteration, the displacement vector at the current time output by the improved diffusion decoder and the reconstructed point cloud at a next time are added to obtain the reconstructed point cloud at the previous time, and the displacement vector at the current time and the latent shape embedding code c are input into the improved diffusion decoder for processing to output the displacement vector at the previous time, until a displacement vector Δ⁽⁰⁾ at time 0 is output. The displacement vector Δ⁽⁰⁾ at time 0 and the reconstructed point cloud at time 1 are added to output a reconstructed point cloud

$${𝒫}_{r}^{( 0 )}$$

at time 0, serving as the final output reconstructed point cloud if the improved diffusion model. Each final output reconstructed point cloud obtained from the training set and the initial input defect 3D point cloud are jointly processed by the loss function of the improved diffusion decoder, and the network weights of the improved diffusion decoder are updated via an optimizer until the loss function converges to obtain a trained improved diffusion decoder, thereby obtaining the trained reconstruction model.

The displacement vector is specifically defined as follows:

$${△}^{( t - 1 )} = \frac{1}{\sqrt{{α}_{t}}} ( {△}^{( t )} - \frac{{β}_{t}}{\sqrt{1 - {\overline{α}}_{t}}} {ϵ}_{θ} ( {△}^{( t )} , {β}_{t} , c ) ) + σ ϵ$$

Wherein Δ^{(t)} and Δ^{(t-1)} are the displacement vectors at time t and time t−1, respectively; αₜ and α̅ₜ are the noise variance and the cumulative variance thereof at time t, respectively, where

$${\overline{α}}_{t} = {\sum }_{s = 0}^{t} {α}_{s} ,$$

with αₛ being the noise variance at time s; βₜ is the noise variance schedule at time t, where βₜ=1−αₜ; ϵ_{θ} is a denoising function; σ is the noise standard deviation; and ϵ is standard Gaussian noise.

In step 4), the detection function comprises a clustering algorithm and a distance function. First, K-nearest neighbor (KNN) clustering is performed on the 3D point cloud to be detected and the reconstructed point cloud thereof, respectively, to obtain two groups of clustered point clouds. The clustered point clouds of the 3D point cloud to be detected and the reconstructed point cloud thereof respectively contains a plurality of initial point cloud clusters and reconstructed point cloud clusters. Then, the two groups of clustered point clouds are measured via the distance function. For each of the initial point cloud clusters, the Euclidean distance between the initial point cloud cluster and each of the reconstructed point cloud clusters is obtained, and the shortest Euclidean distance therein is selected as the segmentation result for the current initial point cloud cluster. For the segmentation result of each initial point cloud cluster, if the segmentation result is not greater than a distance threshold, the location of the current initial point cloud cluster is defect-free; otherwise, it is defective. Simultaneously, the size of the defect can be determined based on the segmentation result, thereby obtaining the defect localization result of the machined surface of the industrial product to be detected. Simultaneously, the longest Euclidean distance among the segmentation results of the initial point cloud clusters is obtained as a classification result. If the classification result is not greater than the distance threshold, the current 3D point cloud to be detected is defect-free; otherwise, it is defective, thereby obtaining the defect classification result of the machined surface of the industrial product to be detected.

An electronic device of the present invention comprises: a memory and a processor coupled to each other, wherein the memory stores program data, and the processor calls the program data to execute the method described above.

A computer-readable storage medium of the present invention stores program data thereon, wherein when the program data being executed by a processor, implements the method described above.

The present invention utilizes data distribution transformation based on a diffusion process. Taking the geometric features of an input abnormal 3D point cloud as a condition, the model learns strict point-wise displacement behavior from a random Gaussian noise 3D point cloud. By progressively correcting the abnormal 3D point cloud, a normal 3D point cloud corresponding to the defective sample is finally obtained. The reconstructed defect-free sample and the corresponding original defective sample are separately clustered. The clustered 3D reconstructed point cloud and the 3D input point cloud are compared using a distance function, wherein outliers with large distance differences are regarded as abnormal points. Thus, the classification result and segmentation result of defect detection are obtained. Furthermore, the method introduces a new 3D point cloud defect simulation strategy to generate realistic and diverse defect shapes, thereby narrowing the domain gap and distribution difference between the training set and the testing set.

The beneficial effects of the present invention are:

The present invention is applicable to defect detection based on 3D expression forms, primarily focusing on 3D point cloud defect detection of machined surfaces of industrial products. The present invention can help solve the lack of defect detection data, large distribution differences between training and testing domains, as well as problems of low precision, high resource occupation, and long inference time in existing methods. The present invention helps solve the problems of slow inference speed and large video memory consumption in existing 3D defect detection methods, realizing rapid and accurate 3D point cloud defect detection. The present invention can be used for online detection of industrial products to improve production efficiency and product quality. By real-time monitoring of products on the production line, non-conforming products can be discovered and eliminated in time, reducing waste while ensuring the reliability and consistency of the final products, contributing to efficient, rapid, and accurate 3D defect detection and quality inspection of industrial assembly line products.

### BRIEF DESCRIPTION OF THE DRAWINGS

FIG. 1 is a training flowchart of the diffusion model of the present invention;

FIG. 2 is a basic architecture diagram of the diffusion model of the present invention;

FIG. 3 is a testing flowchart of the diffusion model of the present invention;

FIG. 4 is a flowchart of the 3D defect simulation of the present invention;

FIG. 5 is a result diagram of 3D defect detection and segmentation of the present invention;

FIG. 6 is a result diagram of 3D defect simulation on the real 3D point cloud defect detection dataset Real3D-AD of the present invention;

FIG. 7 is a result diagram of 3D defect simulation on the simulated 3D point cloud defect dataset Anomaly-ShapeNet of the present invention.

### DESCRIPTION OF THE EMBODIMENTS

To explain the present invention more clearly, the present invention is further described below with reference to the accompanying drawings and embodiments. Those skilled in the art should understand that the content specifically described below is illustrative rather than restrictive and should not limit the scope of protection of the present invention.

The method for defect detection on a machined surface 3D point cloud based on a diffusion model of the present invention is specifically as follows:

First, a plurality of 3D point clouds of machined surfaces of defect-free industrial products are obtained, and data augmentation and point cloud preprocessing are sequentially performed. For each 3D point cloud of the machined surface of a defect-free industrial product, data augmentation comprising global random rotation and local random deformation is sequentially performed on the 3D point cloud. When performing global random rotation, a randomly generated 3×3 rotation matrix is dot-multiplied with the point cloud matrix of the 3D point cloud to obtain a rotated 3D point cloud. Through this random rotation, partial point clouds obtained from scanning at different angles are simulated to enhance the model's robustness to input point clouds at arbitrary angles. Then, local random deformation is performed; partial points in the rotated 3D point cloud are randomly selected for displacement to simulate defect styles including protrusions, indentations, and damage, thereby enhancing the model's ability to reconstruct corresponding defect-free samples when dealing with real 3D defects. Finally, a data-augmented 3D point cloud is obtained. The data-augmented 3D point cloud is subjected to point cloud preprocessing: first performing normalization processing, then translating and scaling the data-augmented 3D point cloud, and subsequently performing random down-sampling to a preset number of point clouds to finally obtain a processed defect 3D point cloud and construct a training set.

In specific implementation of the present invention, global random rotation and local random deformation are used for data augmentation of 3D defects. The input 3D point cloud is transformed by a randomly generated rotation matrix, and partial points closest to a reference point are randomly selected for displacement to simulate defect samples conforming to real 3D point clouds.

The Global Random Rotation is specifically as follows:

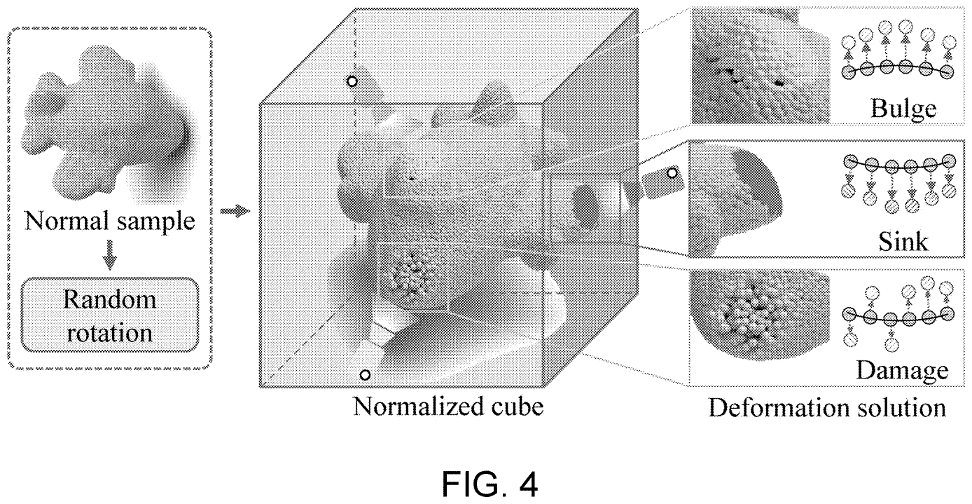

Given that a small number of normal samples is not conducive to the model learning diversity and essential features, leading to the trained model being sensitive to the angle of the input point cloud, the present invention proposes simulating rotation from anomaly-free shapes to enhance the model's robustness to input point cloud angles. As shown in FIG. 4, the input normal point cloud is first randomly rotated. The design purpose of random spatial rotation is to improve the model's generalization ability regarding spatial transformations of test samples, which may be very different. The global random rotation augmentation is defined as follows:

$${𝒫}_{z} = 𝒫 \cdot ℛ$$

Wherein [symbol] and [symbol] _{z} are the normal sample and the rotation-augmented sample, respectively; [symbol] ∈R^{3×3} is a rotation matrix obtained by randomly selecting rotation angles across all three axes. The form of the rotation matrix may be as follows:

$$[ [ \begin{matrix}‐ 0. 4696 \; 788 & 0.05267304 & - 0.99750668\end{matrix} ]$$

$$[ \begin{matrix}- 0.8 \; 2655194 & - 0.56278526 & 0.00920072\end{matrix} ]$$

$$[ \begin{matrix}- 0.5 \; 6089 \; 742 & 0.82492321 & 0.06996984\end{matrix} ] ]$$

The Local Random Deformation is specifically as follows:

In addition to improving the model's robustness to the overall shape of the point cloud via random rotation, the present invention further performs fine-grained local random deformation to encourage the reconstruction model to learn the irregularities of local features. Anomaly-free point clouds and their diverse anomaly modes are integrated into training pairs to learn distinctive features between normal and abnormal surfaces. The intuition is that the diversity of simulated negative samples forces the network to learn how to reconstruct anomaly-free shapes rather than memorizing their complete appearance. As shown in FIG. 4, the present invention randomly selects a viewpoint [symbol] ᵥ from a cube surface and determines a patch [symbol] ₙ of the nearest N points from [symbol] _{z} based on that viewpoint. This local random deformation is defined as follows:

$${𝒫}_{n} = {𝒫}_{n} + S \cdot normalize ( {𝒫}_{n} - {𝒫}_{v} ) ⊙ 𝒯$$

Wherein, “normalize” represents a normalization operation on a vector, S is a predefined hyperparameter used to control the scaling of patch points. By arranging [symbol] sampled from a random Gaussian distribution in ascending or descending order, control over the protrusion or indentation of local defects can be achieved. Directly superimposing [symbol] sampled from a random Gaussian distribution can obtain a simulation of local damage. The final simulated defect point cloud [symbol] ₐ is obtained only by updating the patch region [symbol] ₙ, with the remaining points maintained as sampled from the original point cloud.

Then, an improved diffusion model based on displacement iterative reconstruction is established. The model comprises a PointNet point cloud network encoder and an improved diffusion decoder. During the training process, the improved diffusion model further comprises a noise addition function. The defect 3D point clouds are passed through the PointNet encoder for feature extraction to obtain shape encoding features of the defect 3D point clouds as a latent shape embedding code c. Simultaneously, the defect 3D point clouds are passed through the noise addition function to generate a set of masked point clouds

$${𝒫}_{a}^{( T )}$$

at time T having Markov chain properties. The shape encoding features of the defect 3D point clouds are input into the improved diffusion decoder for processing to output a displacement vector Δ^{(T-1)} at time T−1. The masked point cloud

$${𝒫}_{a}^{( T )}$$

at time T and the displacement vector Δ^{(T-1)} at time T−1 are added to obtain a reconstructed point cloud

$${𝒫}_{r}^{( T - 1 )}$$

at tune T−1. The displacement vector Δ^{(T-1)} at time T−1 and the latent shape embedding code c are input into the improved diffusion decoder for processing to output a displacement vector Δ^{(T-2)} at time T−2. The iterative process is repeated; at each iteration, the displacement vector at the current time output by the improved diffusion decoder and the reconstructed point cloud at a next time are added to obtain the reconstructed point cloud at the previous time, and the displacement vector at the current time and the latent shape embedding code c are input into the improved diffusion decoder for processing to output the displacement vector at the previous time, until a displacement vector Δ⁽⁰⁾ at time 0 is output. The displacement vector Δ⁽⁰⁾ at time 0 and the reconstructed point cloud at time 1 are added to output a reconstructed point cloud

$${𝒫}_{r}^{( 0 )}$$

at time 0, serving as the final output reconstructed point cloud of the improved diffusion model. Each final output reconstructed point cloud obtained from the training set and the initial input defect 3D point cloud are jointly processed by the loss function of the improved diffusion decoder, and the network weights of the improved diffusion decoder are updated via an optimizer until the loss function converges to obtain a trained improved diffusion decoder, thereby obtaining the trained reconstruction model.

The present invention utilizes the improved diffusion model to reconstruct the input 3D point cloud. Via the diffusion model, the defect-free point cloud corresponding to the input point cloud is reconstructed step-by-step from noise in a Markov chain manner, starting from completely random Gaussian noise, using features extracted from the input point cloud by the PointNet encoder as a condition. In specific implementation, an improved Denoising Diffusion Probabilistic Model (DDPM) is used for point cloud reconstruction. The DDPM contains a diffusion process and a reverse process. The forward Markov process gradually adds Gaussian noise to clean samples from the data distribution and transforms them into Gaussian noise; the reverse process is also a Markov process, which denoises through a series of steps to generate meaningful data from the target distribution. The reverse process denoises noise from the fully masked distribution.

The present invention formulates the point cloud reconstruction task of anomaly-free models as a conditional generation problem. This problem decodes the explicit displacements in the target distribution

$$q ( {𝒫}_{r} \vert {𝒫}_{a}^{( T )} , c ) ,$$

where c is the decoding condition, i.e., the latent shape embedding code. The core problem of 3D point cloud anomaly detection is, how to conditionally reconstruct anomaly-free shapes when referencing to input point clouds with different spatial transformations. In the self-supervised reconstruction process, effective global features are extracted from the input as auxiliary conditional embedding codes for the denoising function ϵ_{θ}. The present invention uses the latent shape embedding code c as a conditional input in the reverse diffusion process to guide reconstruction.

The present invention uses a feature encoder to encode the point cloud into a latent shape embedding code c containing high-level features for the conditional generation process. The feature encoder mainly consists of a cascaded multilayer perceptron based on the PointNet architecture. It performs max pooling after mapping the point cloud

$${𝒫}_{a}^{( 0 )}$$

to different dimensions, and then compresses them to extract global shape embeddings. To progressively generate point embeddings, a series of global features

$${\{ {X}_{j} \}}_{j = 1}^{m = 4} ∈ {R}^{k \times N}$$

are extracted from the input point cloud through a 4-layer cascaded convolutional-based multilayer perceptron, where j is the layer index, representing the feature extracted at the j-th layer; m is the total number of layers, representing the total number of layers in the convolutional-based multilayer perceptron; k is the number of feature channels; and N is the number of points in the point cloud, representing the size of the input point cloud. Subsequently, these features are max-pooled and input into a 3-layer linear basic multilayer perceptron to learn the latent feature vector

$${\{ {F}_{i} \}}_{i = 1}^{m = 3} ∈ {R}^{d} ,$$

where d is the dimension of the latent feature vector, representing the size of the encoded feature representation. The output latent shape embedding code c=Fₗ represents global structure and pose information and serves as the conditional input for the decoder.

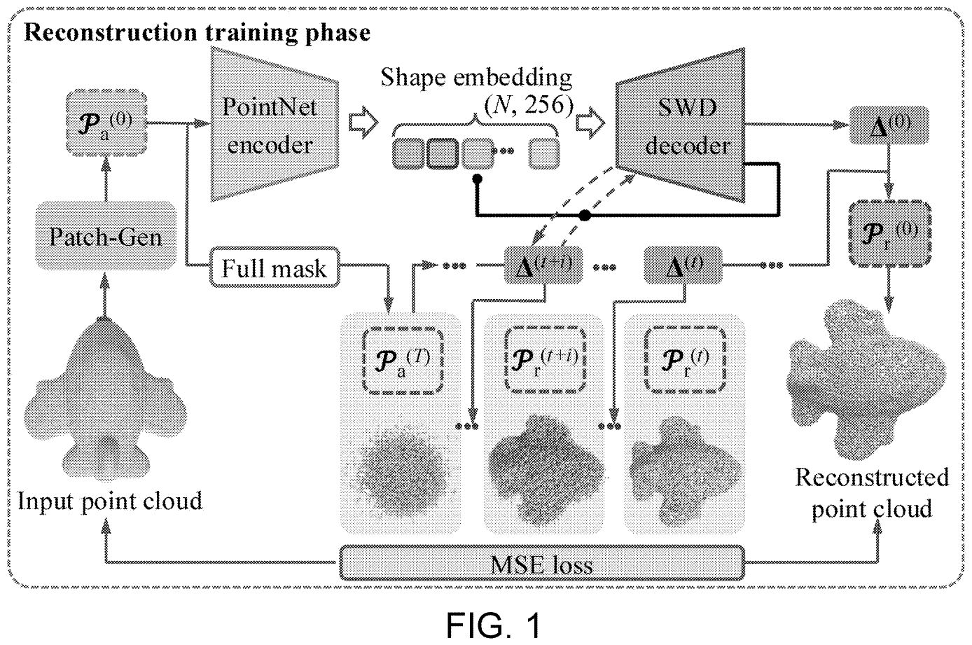

As shown in FIG. 1, to achieve point cloud reconstruction with transformation consistency while preserving the structure of non-abnormal regions, the method of the present invention injects the latent shape embedding c into the decoder at each step of the back-diffusion process. In principle, during the training phase, the denoising function Ee models the conditional probability distribution by learning the Gaussian noise added during the forward diffusion process through the decoder. The present invention utilizes Gaussian noise during the forward process to completely mask the point cloud objects, thus solving the mapping degradation problem of traditional autoencoders. The masked points

$${𝒫}_{a}^{( T )}$$

and the latent shape embedding code c∈R²⁵⁶ serve as inputs to the decoder. At each step of the iterative process, a point-level displacement vector Δ^{(t)} is generated, thereby separating the predicted noise from the desired non-abnormal shape. The displacement vector can be expressed as:

$${Δ}^{( t + i )} = \frac{1}{\sqrt{{α}_{t + i + 1}}} ( {Δ}^{( t + i + 1 )} - \frac{{β}_{t + i + 1}}{\sqrt{1 - {\overline{α}}_{t + i + 1}}} {ϵ}_{θ} ( {Δ}^{( t + i + 1 )} , {β}_{t + i + 1} , c ) ) + σϵ$$

Wherein Δ^{(t+i)} and Δ^{(t+i+1)} are displacement vectors at time t+i and time t+i+1, respectively; αₜ₊ᵢ₊₁ and α̅ₜ₊ᵢ₊₁ are the noise variance and cumulative variance at time t+i+1, respectively,

$${\overline{α}}_{t + i + 1} = {\prod }_{s = 0}^{t + i + 1} {α}_{s} ,$$

αₛ is the noise variance at time s, βₜ₊ᵢ₊₁ is the noise variance scheduling at time t+i+1, βₜ₊ᵢ₊₁=1−αₜ₊ᵢ₊₁; ϵ_{θ} is the denoising function used to estimate noise; σ is the noise standard deviation, which is an adjustable parameter; and ϵ is standard Gaussian noise, ϵ~N(0, I).

The network uses Δ^{(t-1)} to decode the denoising function Ee and latent shape embedding code c from the previous step. A triangular position embedding eₚ=(βₜ, sin(βₜ), cos(βₜ)) is generated using variance scheduling βₜ. The triangular position embedding eₚ is concatenated with the latent shape embedding code c and input into the linear module of the network, along with the residual function. The output reconstructed point cloud at step t is:

$${𝒫}_{r}^{( t )} = {𝒫}_{r}^{( t + 1 )} + {Δ}^{( t )}$$

In the model training process, when performing an object reconstruction task involving N points, the network learns a diffusion model with a mapping relationship of R^{N×3}→R^{N×3}. Through iterative denoising and under the semantic conditions of point embedding, prediction of point displacement is achieved. Specifically, the network is trained to learn the noise that needs to be eliminated to restore the anomaly-free shape; this process is based on the L₂ distance between the ground truth and the denoised reconstructed points.

To evaluate the element-wise distance between the original point cloud

$${𝒫}_{a}^{( 0 )}$$

and the reconstructed point cloud

$${𝒫}_{r}^{( 0 )} ,$$

the present invention uses Mean Squared Error (MSE) loss as the primary reconstruction loss, specifically as follows:

$${ℒ}_{{𝒫}_{𝒶} , {𝒫}_{𝓇}} = \frac{1}{N} {\sum }_{i = 1}^{N} {\{}_{{p}_{a} ∈ {𝒫}_{a} , {p}_{r} ∈ {𝒫}_{r}} {‖ {p}_{a} - {p}_{r} ‖}^{2}$$

Wherein pₐ∈ [symbol] ₐ represents a point from the original abnormal point cloud, and pᵣ∈ [symbol] ᵣ represents a point from the reconstructed point cloud, corresponding to the reconstructed point; The superscript (0) of the original point cloud indicates the point cloud in its initial state, i.e., the state before any noise has been added during diffusion or just beginning denoising. N is the number of points, Σ is the sum of all N points, and ∥⋅∥² represents the square of the Euclidean distance between two points. This loss function calculates the mean squared distance of all point pairs between the original point cloud and the reconstructed point cloud, aiming to minimize the difference between the two, thereby improving reconstruction quality.

In the training process, by minimizing the loss function, the network can learn how to progressively remove the Gaussian noise added during forward diffusion, ultimately generating a point cloud with a shape close to the original and free of anomalies. This method helps maintain the structural features of the point cloud while correcting anomalies, ensuring the reconstruction result reflects the true form of the input object as accurately as possible.

The method of the present invention addresses the mapping degradation problem of traditional autoencoders by minimizing the difference between the reconstructed model and the input point cloud after each denoising step. Defective 3D point clouds completely obscure point cloud objects by Gaussian noise during the forward process using a noise addition function. This invention reconstructs the input 3D point cloud using the improved diffusion model. A diffusion decoder, using features extracted from the input point cloud by the PointNet encoder as conditions, generates point-level displacement vectors from the noise step-by-step using a Markov chain. The generated point cloud group serves as the target reference, and a mean square loss function is used to iteratively reconstruct a defect-free point cloud corresponding to the input point cloud. By updating the neural network weights via the Adam optimizer to minimize the loss function, the diffusion model acquires the ability to progressively denoise from random noise and finally restore the original point cloud.

In specific implementation, obtaining a 3D point cloud of a machined surface of an industrial product to be detected, performing the same point cloud preprocessing, then inputting the preprocessed point cloud into the reconstruction model for processing, and obtaining a reconstructed point cloud upon completion of processing, and subjected to point cloud preprocessing. Finally, detecting and segmenting the 3D point cloud to be detected and the reconstructed point cloud thereof via a detection function. The detection function comprises a clustering algorithm and a distance function. K-nearest neighbor (KNN) clustering is first performed on the 3D point cloud to be detected and the reconstructed point cloud thereof, respectively, to obtain two groups of clustered point clouds, wherein the clustered point clouds of the 3D point cloud to be detected and the reconstructed point cloud thereof respectively contains a plurality of initial point cloud clusters and reconstructed point cloud clusters. Then, the two groups of clustered point clouds are measured via the distance function; for each of the initial point cloud clusters, an Euclidean distance between the initial point cloud cluster and each of the reconstructed point cloud clusters is obtained, and a shortest Euclidean distance therein is selected as a segmentation result for a current initial point cloud cluster. For the segmentation result of each initial point cloud cluster, if the segmentation result is not greater than a distance threshold, a location of the current initial point cloud cluster is defect-free; otherwise, it is defective, and also determines the size of the defect based on the segmentation results, thereby obtaining a defect localization result of the machined surface of the industrial product to be detected. Simultaneously, a longest Euclidean distance among the segmentation result of the initial point cloud clusters is obtained as a classification result; if the classification result is not greater than the distance threshold, the current 3D point cloud to be detected is defect-free; otherwise, it is defective, thereby obtaining the defect classification result of the machined surface of the industrial product to be detected, thereby completing the defect detection of the machined surface of the industrial product.

In the training phase of the present invention, the input 3D point cloud undergoes preprocessing, and then undergoes data augmentation using 3D defect simulation strategy. Using the augmented point cloud as a condition and the preprocessed input point cloud as the target, the diffusion model is trained to reconstruct the corresponding 3D point cloud from completely random noise. In the testing phase, the preprocessed input point cloud is used as a condition, and the trained reconstruction model reconstructs the defect-free point cloud corresponding to the input sample from completely random noise, thereby obtains the final defect detection, classification, and segmentation results through comparison using clustering algorithms and Euclidean distance. The present invention is oriented toward 3D form expression, reconstructing defect-free features corresponding to input samples based on a diffusion model, detecting and segmenting by comparing original features and reconstruction via clustering and distance functions, and performing data augmentation via a new 3D point cloud defect simulation strategy.

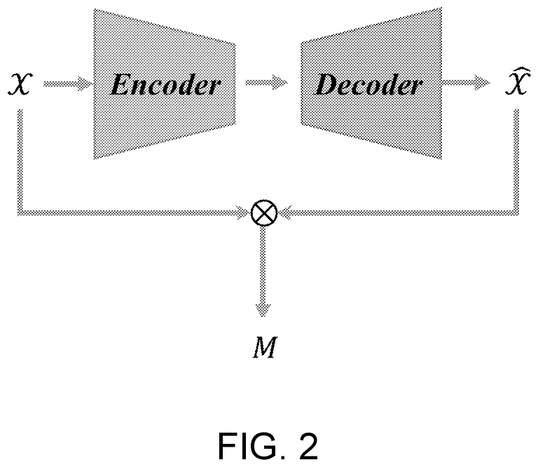

As shown in FIG. 2, in the inference phase stage of this invention, the defect point cloud X input to the reconstruction model and the reconstructed point cloud \hat{X} after the diffusion model are compared using a detection function to obtain a defect map M containing information such as the location and confidence level of specific defects. The diffusion model consists of two main components: an encoder and a decoder. The diffusion model network is trained end-to-end on a given 3D point cloud data category using the backpropagation algorithm to ultimately obtain the reconstruction model. The clustering algorithm and distance function of the detection function are used to detect and segment the original point cloud and the reconstructed point cloud. By performing K-nearest neighbor clustering on both the input point clouds and the reconstructed point clouds, and measuring the clustered point clouds using a distance function, the defect detection classification and segmentation results of the point clouds are obtained based on the measurement results. Specifically including the following steps:

First, point cloud preprocessing and clustering are performed. The input point cloud data is standardized to eliminate the influence of different scales. For a point cloud P={p₁, p₂, . . . , p_{N}}, each point pᵢ∈R³ is represented as (xᵢ, yᵢ, zᵢ). This invention applies a normalization transformation to all points. The original point cloud P and the reconstructed point cloud \hat{P}, after standardization, are respectively represented by the coordinate sets of the K nearest neighbors obtained by the K-nearest neighbor clustering algorithm, denoted as [symbol] ₖₙₙ(pᵢ) and [symbol] . For each sample pᵢ, k nearest other samples pⱼ are found, and a tensor composed of these neighbors is returned.

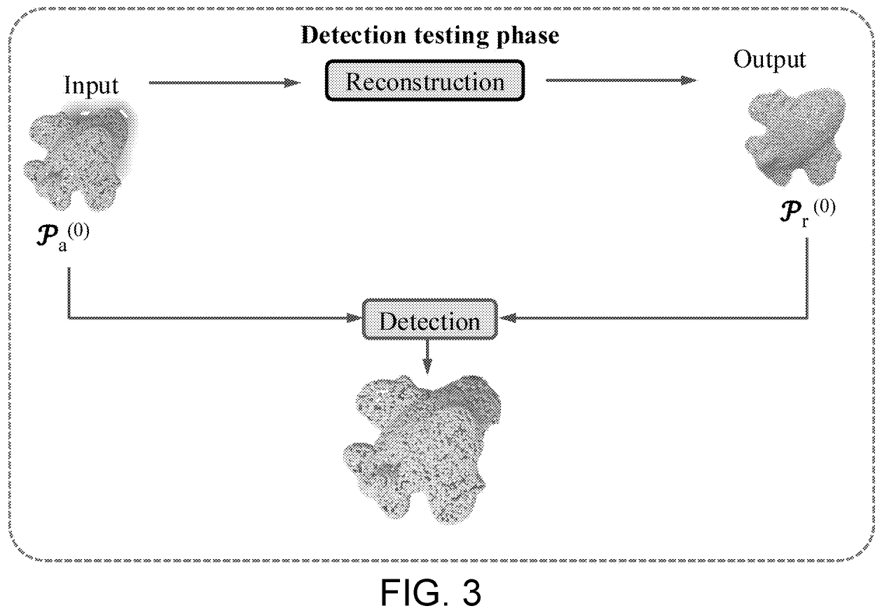

Then, point cloud defect detection and segmentation are performed. As shown in FIG. 3, the present invention calculates the similarity between Pₖₙₙ and [symbol] via the distance function in the detection function. Euclidean distance is used to measure the distance between two points. The relative distance matrix between the two point clouds is obtained by calculating the distance between [symbol] ₖₙₙ(pᵢ) and [symbol] after clustering. The maximum value therein is taken as the anomaly detection classification score, and all values greater than a certain threshold are taken as anomaly detection segmentation scores.

In specific implementation, the present invention uses 3D point clouds of machined surfaces of industrial products to train and test the model. The Real3D-AD dataset, a real 3D point cloud defect detection dataset, contains 12 categories, with each category having a training set of 4 samples and a test set of 100 samples. The simulated 3D point cloud defect dataset Anomaly-ShapeNet contains 40 categories, with each category containing 4 training samples and about 400 test samples.

The present invention is implemented using PyTorch and trained end-to-end in the network. The optimization process employs the Adam optimizer with an initial learning rate of 0.001. The training process consists of 40,000 iterations with a total batch size of 128 to ensure comprehensive learning. All input point cloud data undergoes preprocessing: on the Real3D-AD dataset (a real 3D point cloud defect detection dataset), 4096 points are randomly downsampled; while on the Anomaly-ShapeNet dataset (a simulated 3D point cloud defect dataset), 2048 points are downsampled. Additionally, the present invention standardizes these point clouds by setting the center of gravity of the point cloud as the origin of coordinates and scaling its size to the range of −1 to 1 to optimize the diffusion process.

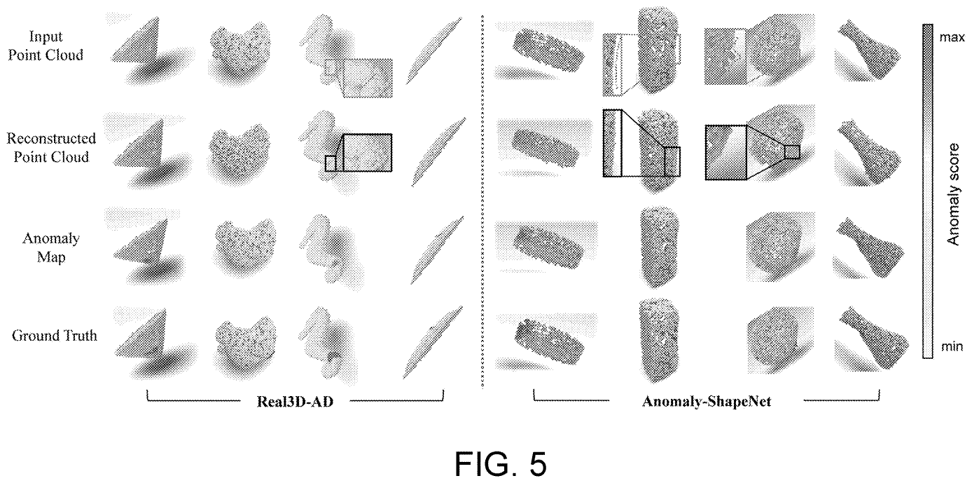

As shown in FIG. 5, qualitative results of the real 3D point cloud defect detection dataset Real3D-AD are illustrated, wherein different color intensities represent different levels of anomaly scores, i.e., confidence levels. Left side of FIG. 5 illustrates samples from the Real3D-AD dataset, while the right side illustrates samples from the Anomaly-ShapeNet dataset for detecting defects in simulated 3D point clouds. By comparing the defect predictions and the ground truth values of the input and reconstructed point clouds, it can be seen that the present invention accurately reconstructs defective parts in the point clouds across various samples: for example, deep depressions in the hippocampus sample, concavities in the bag sample, and bulges in the jar sample. By utilizing accurately reconstructed point clouds, the present invention also generates final point cloud segmentation maps, further proving the effectiveness of the method.

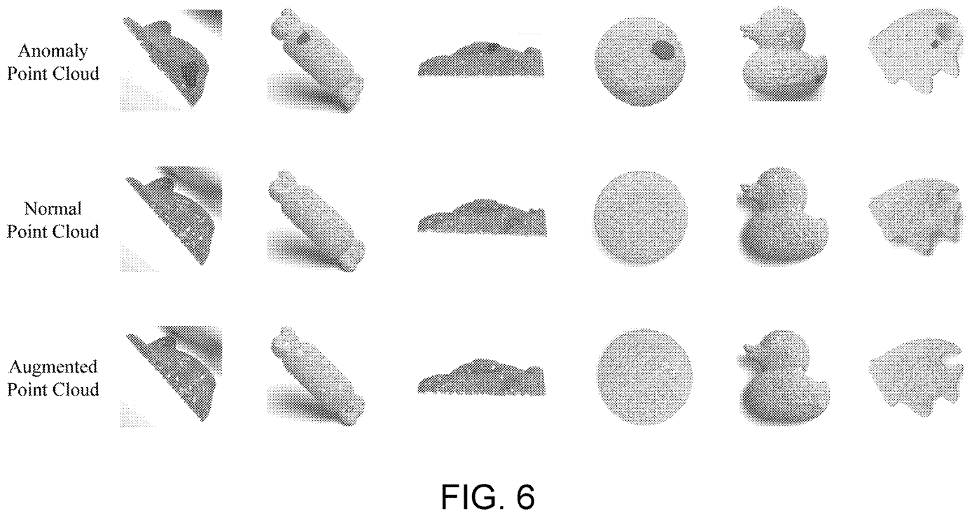

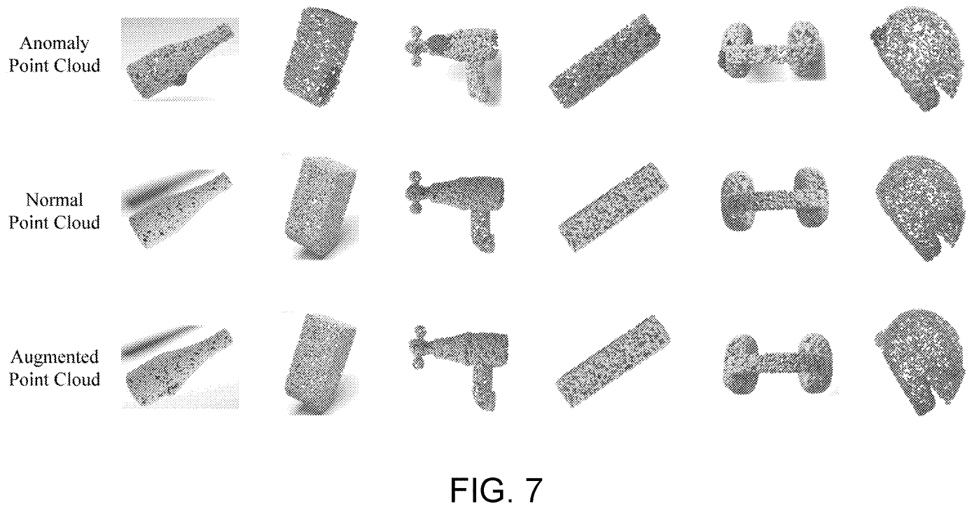

FIG. 6 and FIG. 7 illustrate the anomalous samples in the test set, the normal samples in the training set, and the anomalous samples obtained through the 3D defect simulation strategy. It can be seen that the present invention can comprehensively simulate defects existing in different categories, demonstrating that the method of the present invention can effectively compensate for the domain gap caused by using only positive samples for training in 3D anomaly detection. By generating simulated anomalous samples, the model can be exposed to more diverse anomaly situations during the training phase, thereby improving its generalization ability and the accuracy of detecting real-world anomalies. This enhanced data diversity helps improve the robustness and adaptability of the model, making it perform better when facing real-world anomalies.

Those skilled in the art should understand that the embodiments of the present application can be provided as a method, a system, or a computer program product. Therefore, the present application can take the form of a completely hardware embodiment, a completely software embodiment, or an embodiment combining software and hardware aspects. Furthermore, the present application can take the form of a computer program product implemented on one or more computer-usable storage media (including but not limited to disk storage, optical storage, etc.) containing computer-usable program code. The solutions in the embodiments of the present application can be implemented in various computer languages. The present application is described with reference to flowcharts of methods, systems, and computer program products according to embodiments of the present application.

Although preferred embodiments of the present application have been described, those skilled in the art, upon learning the basic inventive concept, can make other changes and modifications to these embodiments. Therefore, the present invention is intended to be interpreted as including the preferred embodiments and all changes and modifications falling within the scope of the present application.

Obviously, those skilled in the art can make various modifications and variations to the present application without departing from the spirit and scope of the present application. Thus, if these modifications and variations of the present application fall within the scope of the claims of the present invention and their equivalent technologies, the present application is also intended to include these modifications and variations.

What is claimed is:

1. A method for defect detection on a machined surface 3D (three-dimensional) point cloud based on a diffusion model, comprising:
1) obtaining a plurality of 3D point clouds of machined surfaces of defect-free industrial products and sequentially performing data augmentation and point cloud preprocessing, thereby obtaining defect 3D point clouds and constructing a training set;
2) establishing an improved diffusion model based on displacement iterative reconstruction, and inputting the training set into the improved diffusion model for training until a loss function of the improved diffusion model converges, thereby obtaining a trained reconstruction model;
3) obtaining a 3D point cloud of a machined surface of an industrial product to be detected, performing the same point cloud preprocessing as in step 1), inputting the preprocessed point cloud into the reconstruction model for processing, and obtaining a reconstructed point cloud upon completion of processing; and
4) detecting and segmenting the 3D point cloud to be detected and the reconstructed point cloud thereof via a detection function to obtain defect detection classification and localization results, thereby completing the defect detection of the machined surface of the industrial product.

2. The method for defect detection on the machined surface 3D point cloud based on the diffusion model according to claim 1, wherein in step 1), for each 3D point cloud of the machined surface of the defect-free industrial products, data augmentation is performed by sequentially applying a global random rotation and a local random deformation to the 3D point cloud; wherein performing the global random rotation comprises dot-multiplying a randomly generated rotation matrix with a point cloud matrix of the 3D point cloud to obtain a rotated 3D point cloud; and subsequently performing the local random deformation comprises randomly selecting partial points in the rotated 3D point cloud for displacement to finally obtain a data-augmented 3D point cloud.

3. The method for defect detection on the machined surface 3D point cloud based on the diffusion model according to claim 1, wherein in step 1), a data-augmented 3D point cloud is subjected to point cloud preprocessing, which comprises first performing a normalization processing, subsequently translating and scaling the data-augmented 3D point cloud, and then performing random down-sampling to a preset number of point clouds to finally obtain a processed defect 3D point cloud and construct the training set.

4. The method for defect detection on the machined surface 3D point cloud based on the diffusion model according to claim 1, wherein in step 2), the improved diffusion model based on displacement iterative reconstruction comprises a PointNet point cloud network encoder and an improved diffusion decoder;
wherein during a training process, the improved diffusion model further comprises a noise addition function;
the defect 3D point clouds are passed through the PointNet point cloud network encoder for feature extraction to obtain shape encoding features of the defect 3D point clouds as a latent shape embedding code c;
simultaneously, the defect 3D point clouds are passed through the noise addition function to generate a set of masked point clouds
$${𝒫}_{a}^{( T )}$$
at time T having Markov chain properties;
the shape encoding features of the defect 3D point clouds are input into the improved diffusion decoder for processing to output a displacement vector Δ^{(T-1)} at time T−1;
the masked point clouds
$${𝒫}_{a}^{( T )}$$
at time T and the displacement vector Δ^{(T-1)} at time T−1 are added to obtain a reconstructed point cloud
$${𝒫}_{r}^{( T - 1 )}$$
at time T−1;
the displacement vector Δ^{(T-1)} at time T−1 and the latent shape embedding code c are input into the improved diffusion decoder for processing to output a displacement vector Δ^{(T-2)} at time T−2;
an iterative process is repeated, wherein at each iteration, the displacement vector at a current time output by the improved diffusion decoder and the reconstructed point cloud at a next time are added to obtain the reconstructed point cloud at a previous time, and the displacement vector at the current time and the latent shape embedding code c are input into the improved diffusion decoder for processing to output the displacement vector at the previous time, until a displacement vector Δ⁽⁰⁾ at time 0 is output;
the displacement vector Δ⁽⁰⁾ at time 0 and the reconstructed point cloud at time 1 are added to output a reconstructed point cloud
$${𝒫}_{r}^{( 0 )}$$
at time 0, serving as a final output reconstructed point cloud of the improved diffusion model;
each final output reconstructed point cloud obtained from the training set and an initial input defect 3D point cloud are jointly processed by the loss function of the improved diffusion decoder, and network weights of the improved diffusion decoder are updated via an optimizer until the loss function converges to obtain a trained improved diffusion decoder, thereby obtaining the trained reconstruction model.

5. The method for defect detection on the machined surface 3D point cloud based on the diffusion model according to claim 4, wherein the displacement vector is defined as follows:
$${Δ}^{( t - i )} = \frac{1}{\sqrt{{α}_{t}}} ( {Δ}^{( t )} - \frac{{β}_{t}}{\sqrt{1 - {\overline{α}}_{t}}} {ϵ}_{θ} ( {Δ}^{( t )} , {β}_{t} , c ) ) + σϵ$$
wherein Δ^{(t))} and Δ^{(t-1)} are displacement vectors at time t and time t−1, respectively; αₜ and α̅ₜ are a noise variance and a cumulative variance thereof at time t, respectively; βₜ is a noise variance schedule at time t, such that βₜ=1−αₜ; ϵ_{θ} is a denoising function; σ is a standard deviation of noise; and ϵ is standard Gaussian noise.

6. The method for defect detection on the machined surface 3D point cloud based on the diffusion model according to claim 1, wherein in step 4), the detection function comprises a clustering algorithm and a distance function;
wherein K-nearest neighbor (KNN) clustering is first performed on the 3D point cloud to be detected and the reconstructed point cloud thereof, respectively, to obtain two groups of clustered point clouds, wherein the clustered point clouds of the 3D point cloud to be detected and the reconstructed point cloud thereof respectively contains a plurality of initial point cloud clusters and reconstructed point cloud clusters;
then, the two groups of clustered point clouds are measured via the distance function; for each of the initial point cloud clusters, an Euclidean distance between the initial point cloud cluster and each of the reconstructed point cloud clusters is obtained, and a shortest Euclidean distance therein is selected as a segmentation result for a current initial point cloud cluster;
for the segmentation result of each initial point cloud cluster, if the segmentation result is not greater than a distance threshold, a location of the current initial point cloud cluster is defect-free; otherwise, it is defective, thereby obtaining a defect localization result of the machined surface of the industrial product to be detected;
simultaneously, a longest Euclidean distance among the segmentation result of the initial point cloud clusters is obtained as a classification result; if the classification result is not greater than the distance threshold, a current 3D point cloud to be detected is defect-free; otherwise, it is defective, thereby obtaining a defect classification result of the machined surface of the industrial product to be detected.

7. An electronic device, comprising: a memory and a processor coupled to each other, wherein the memory stores program data, and the processor calls the program data to execute the method according to claim 1.

8. A computer-readable storage medium storing program data thereon, wherein when the program data being executed by a processor, implements the method according to claim 1.
